(19) United States
(12) Patent Application Publication
(10) Pub. No.: US 2011/0050459 A1
(43) Pub. Date: Mar. 3, 2011

(54) SYSTEM AND METHOD TO ENHANCE SAFETY AND LEGAL COMPLIANCE BY LOCATION ANALYSIS

(75) Inventors: S. Rao Vasireddy, Holmdel, NJ (US); Uma Chandrashekhar, Morganville, NJ (US)

(73) Assignee: Alcatel-Lucent USA Inc., Murray Hill, NJ (US)

(21) Appl. No.: 12/549,607

(22) Filed: Aug. 28, 2009

(51) Int. Cl. G08G 1/09

(52) U.S. Cl. 340/905

(57) ABSTRACT

Various exemplary embodiments relate to a method and related device including one or more of the following: determining a current location of the vehicle; determining, for the current location, an appropriate maximum speed which the vehicle should not exceed; determining a current speed at which the vehicle is traveling; determining whether the current speed is greater than the appropriate maximum speed; and indicating to the operator of the vehicle, when the current speed is greater than the appropriate maximum speed, that the vehicle is traveling at a speed that is greater than the appropriate maximum speed. Various alternative embodiments also provide for predicting a future speed of the vehicle using the current acceleration and indicating to the operator, when the future speed is greater than the appropriate maximum speed, that the vehicle will soon be traveling at a speed that is greater than the appropriate maximum speed.

### TECHNICAL FIELD

Various exemplary embodiments relate generally to devices for speed detection and warnings.

### BACKGROUND

Having the capability of traveling at very high speeds in automobiles and other vehicles can lead to violation of traffic laws and potentially cause great injury and, oftentimes, death to passengers. For example, in the event of a collision with another vehicle, a person may be subjected to massive amounts of force, as the other vehicle's traveling speed also contributes to the force of the impact.

Recognizing the danger posed by automobiles traveling at excessive speeds, the United Kingdom passed the Locomotive Act of 1861, thus instituting the first legal limit on the speed at which automobiles may travel: 10 miles per hour (mph). As time went on, the idea of a “speed limit” was adopted by most other countries. While speed limits today are generally higher than 10 mph, the concept remains the same: when an automobile is traveling at a speed higher than the applicable speed limit, a police officer or other person of authority stop the automobile and will usually require the driver to pay a fine or at least listen to a stern warning.

Speed limits are enforced on land as well as on water. For example, many waterways have designated “no wake” areas. While in such a no wake area, watercraft are typically not permitted to travel faster than their idle speed. As with automobile speed limits, watercraft speed limits are enforced by officers with the authority to impose fines.

In order to comply with speed limits, the operator of a vehicle must be aware of the speed limit in effect for the area in which the vehicle is traveling. Additionally, because different speed limits may be associated with different stretches of road or water, the operator must keep an eye out for speed limit changes. This can be quite a lot to consider on top of trying to operate a vehicle and navigate. Oftentimes, a vehicle operator may not see a sign indicating a speed limit. Unfortunately, this consideration is typically not persuasive enough to convince a police officer to not issue a speeding ticket.

While aware of the current speed limit, the operator must continually monitor the speed of their vehicle to ensure that it does not surpass the speed limit. Most vehicles include speedometer devices to help the operator accurately gauge the current speed of their vehicle and keep it below the speed limit. These devices, however, are passive. The operator must periodically read the value displayed on a speedometer and process the information along with the speed limit in order to make a decision as to whether the current speed and acceleration may be legally maintained. It is possible for the operator to forget to monitor their current speed and unknowingly exceed the speed limit. Again, this is not a persuasive argument when trying to avoid a speeding ticket.

Aside from legal considerations, other factors influence the speed at which an operator of a vehicle may wish to travel. For example, when it is raining or snowing, the operator may wish to drive at a slower speed than normal to avoid losing control of their vehicle. Road conditions may similarly affect the appropriate maximum speed at which a vehicle should travel. If there is road construction in the area or if there is higher-than-usual traffic, the operator may wish to slow down in order to cope with any sudden and unexpected events, such as other vehicles quickly slowing down or stopping. Again, the operator must continually monitor his or her speedometer with these considerations in mind to make decisions regarding the vehicle's speed.

Accordingly, there exists a need for a method of preventing a vehicle operator from inadvertently exceeding a speed limit. There further exists a need for a method of relieving a vehicle operator's need to periodically look away from the road to read their speedometer and make decisions regarding their traveling speed.

The foregoing objects and advantages of the invention are illustrative of those that can be achieved by the various exemplary embodiments and are not intended to be exhaustive or limiting of the possible advantages that can be realized. Thus, these and other objects and advantages of the various exemplary embodiments will be apparent from the description herein or can be learned from practicing the various exemplary embodiments, both as embodied herein or as modified in view of any variation that may be apparent to those skilled in the art. Accordingly, the present invention resides in the novel methods, arrangements, combinations, and improvements herein shown and described in various exemplary embodiments.

### SUMMARY

In light of the present need for a method of preventing a vehicle operator from inadvertently exceeding a speed limit, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method and related device including one or more of the following: determining a current location of a vehicle; determining, for the current location, an appropriate maximum speed which the vehicle should not exceed; determining a current speed at which the vehicle is traveling; determining whether the current speed is greater than the appropriate maximum speed; and indicating to the operator of the vehicle, when the current speed is greater than the appropriate maximum speed, that the vehicle is traveling at a speed that is greater than the appropriate maximum speed.

It should be apparent that, in this manner, various exemplary embodiments enable the provision of speed warnings to a vehicle operator when the vehicle is exceeding the speed limit or some other advisable speed. In particular, by constantly monitoring its speed and comparing it to an applicable speed limit, an electronic device can intelligently warn a driver when they are either currently or about to be traveling too fast. Thus, various exemplary embodiments enable an operator of a vehicle to focus on other considerations, such as vehicle operation and navigation, rather than paying close attention to their speed.

### BRIEF DESCRIPTION OF THE DRAWINGS

In order to better understand various exemplary embodiments, reference is made to the accompanying drawings, wherein:

FIG. 1 is a drawing of an exemplary environment for the operation of a speed warning device;

FIG. 2 is a schematic diagram of an exemplary method of determining the current location of a speed warning device;

FIG. 3 is a schematic diagram of an exemplary implementation of a speed warning device;

FIG. 4 is a schematic diagram of an alternative implementation of a speed warning device;

FIG. 5 is a graph of an exemplary set of speeds measured by a speed warning device over a specific time period;

FIG. 6 is a flowchart of an exemplary method for warning a vehicle operator when the speed of a vehicle exceeds or may exceed an appropriate maximum speed; and

FIG. 7 is a flowchart of an exemplary method for determining an appropriate maximum speed which a vehicle should not exceed.

### DETAILED DESCRIPTION

Referring now to the drawings, in which like numerals refer to like components or steps, there are disclosed broad aspects of various exemplary embodiments. It should be noted that the present invention is not intended to be limited to automobiles, but is instead applicable to any vehicle that might be subject to a limit on speed. Accordingly, any references to objects that are specific to one type of vehicle should be construed to encompass the equivalents for other vehicle types. For example, the term “road” should be construed to encompass “waterways” and vice versa.

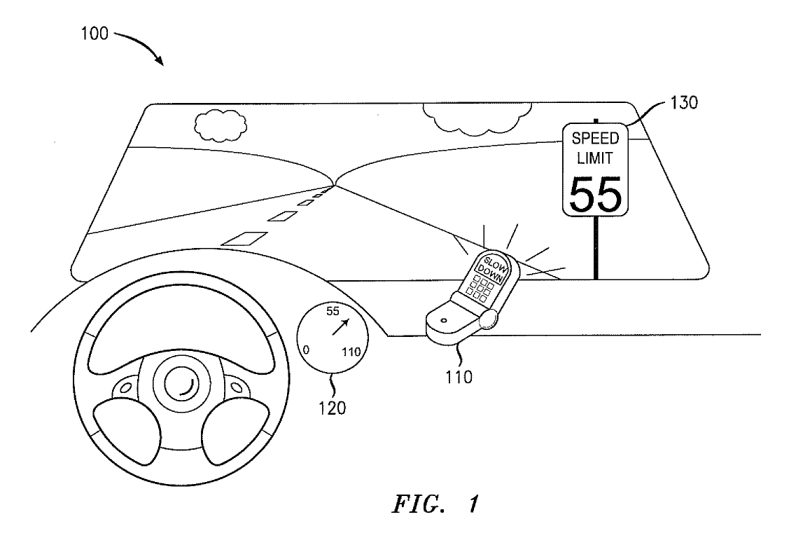

FIG. 1 is a drawing of an exemplary environment 100 for the operation of speed warning device 110. Exemplary environment 100 may comprise the interior of an automobile, the deck of a watercraft, or any operations area for a vehicle of any kind. Exemplary environment 100 may include the speed warning device 110, a speed gauge 120, and a speed limit indicator 130.

Speed warning device 110 may be any electronic device capable of monitoring its location and issuing a warning to the operator of the vehicle. For example, speed warning device 110 may be a cellular telephone, a wireless email device, a global positioning system (GPS) device, or a laptop computer. Speed warning device 110 may include a means for visually and/or aurally communicating a warning to the operator or it may interface with another means for communicating with the operator such as, for example, an audio system of the vehicle. Alternatively, speed warning device 110 may be an integrated component of the vehicle itself as a factory installed or after-market component.

Speed gauge 120 may be any means for displaying to the operator a current speed of the vehicle, such as a conventional speedometer. Speed limit indicator 130 may be any means for indicating a current legal speed limit to the operator, such as a road sign.

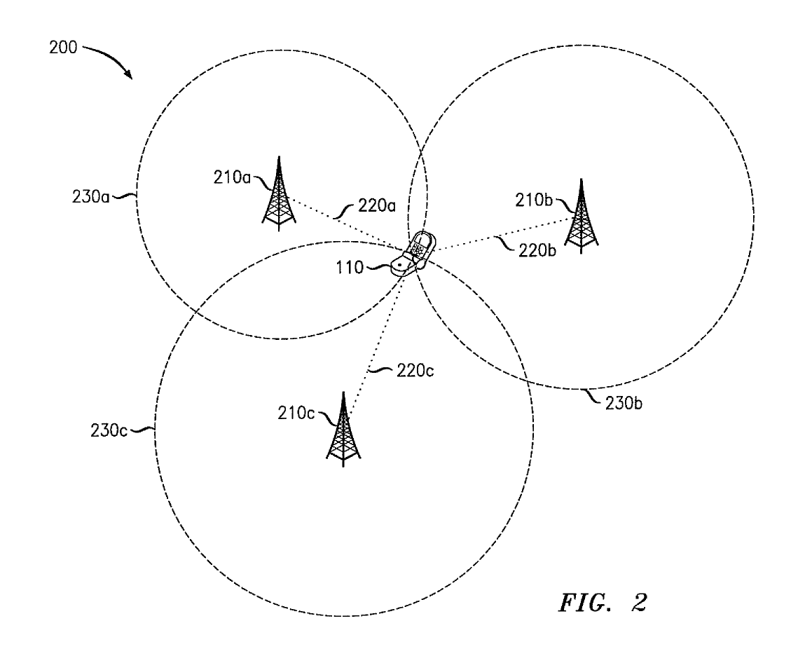

Having described the components of environment 100, a brief summary of the operation of speed warning device 110 will be provided. It should be apparent that the following description is intended to provide an overview of the operation of speed warning device 110 and is therefore a simplification in some respects. The detailed operation of speed warning device 110 will be described in further detail below in connection with FIGS. 2-7.

In exemplary environment 100, speed warning device 110 is capable of monitoring the speed at which it is currently traveling. Through this capability, speed warning device 110 knows that it (and by association, the vehicle) is currently traveling at a rate of around 75 mph, in this example scenario, as independently indicated by speed gauge 120. Speed warning device is further capable of determining its current location and a legal speed limit associated with that location. Using this capability, speed warning device knows that the speed limit for its current location is 55 mph, as independently indicated by speed limit indicator 130.

Speed warning device 110 is then able to compare its current speed to the speed limit and determine that the vehicle is currently exceeding the speed limit. Speed warning device 110 then warns the operator that the vehicle should be slowed down by, for example, generating an audio alarm and/or displaying the message “SLOW DOWN.”

FIG. 2 is a schematic diagram of an exemplary method 200 of determining the current location of a speed warning device 110. According to exemplary method 200, three communications devices 210a, 210b, 210c with which speed warning device 110 is in communication are used to triangulate the position of speed warning device 110. Communications devices 210a, 210b, 210c may be any devices capable of wirelessly communicating with speed warning device 110. For example, communications devices 210a, 210b, 210c may be cellular towers or GPS satellites.

To triangulate its location, speed warning device 110 first receives a communications signal 220a from communications device 210a. Using techniques known to those skilled in the art, speed warning device 110 can use signal 220a to determine the distance between communications device 210a and itself. With this piece of distance information and knowledge of the location of communications device 210a (possibly communicated via signal 220a), speed warning device 110 can deduce that it is currently located somewhere on circle 230a.

Speed warning device 110 proceeds to use the same process to determine a distance between itself and communications device 210b using received signal 220b. This distance tells speed warning device 110 that it is also located somewhere on circle 230b. Speed warning device 110 then knows that because it is located on both circles 230a, 230b, it must be located on one of the two points at which circles 230a, 230b intersect.

Using the same process a third and final time, speed warning device 110 can use a signal 220c received from communications device 210c to determine that it must be located somewhere on circle 230c as well. Speed warning device 110 is then able to deduce that it must be located on the single point of intersection of the three circles 230a, 230b, 230c.

Thus, speed warning device 110 may use a triangulation process to monitor its current position. By monitoring its position over time, speed warning device 110 may also approximate its traveling speed and acceleration, as these are defined as the first and second derivatives, respectively, of a function representing its position over time. It should be noted that any method known to those of skill in the art could be used by speed warning device 110 to determine its current location. For example, one alternative embodiment might monitor the speed and bearing (i.e., velocity) of the speed warning device 110 and track its position by continually updating a provided starting position.

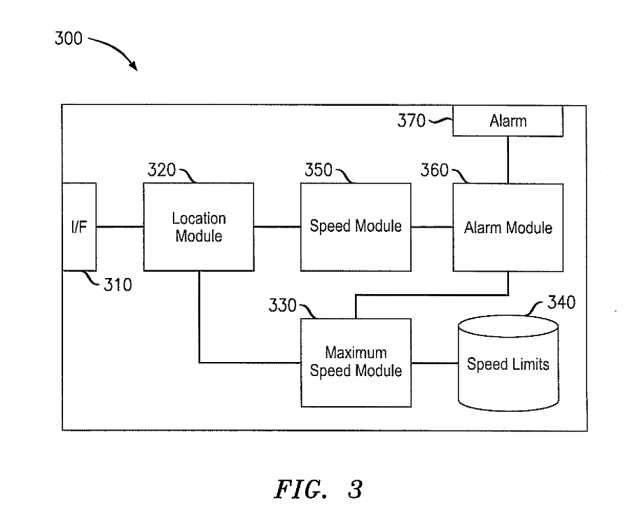

FIG. 3 is a schematic diagram of an exemplary implementation of a speed warning device 300. Speed warning device 300 may include interface 310, location module 320, maximum speed module 330, speed limit storage 340, speed module 350, alarm module 360, and alarm 370. Speed warning device 300 may correspond to speed warning device 110 and may be an independent device or an integrated component of a vehicle.

Interface 310 may be an interface comprising hardware and/or executable instructions encoded on a machine-readable storage medium configured to receive signals from other devices. For example, interface 310 may be a wireless receiver configured to receive signals transmitted from a GPS, 3G, or 4 G communications device. Interface 310 may receive signals useful for determining a current position of speed warning device 300.

Location module 320 may include hardware and/or executable instructions on a machine-readable storage medium configured to determine the current location of speed warning device 300. For example, location module 320 may receive a number of signals via interface 310 and triangulate a position according to the method described above in connection with FIG. 2. In various alternative embodiments, wherein speed module 350 does not depend on the output of location module 320, location module 320 may receive a current speed from speed module 350 and a bearing from a compass module (not shown). Using this information, location module may track the displacement of speed warning device 300 from some starting location in order to monitor the current location.

Location module 320 may be further adapted to resolve the location from a numerical representation of location into an indication of a road on which the vehicle is currently traveling and/or a zip code in which the vehicle is currently located. In resolving the location into an indication of a road and/or zip code, location module 320 may communicate via interface 310 with a server providing this functionality or location module 320 may be equipped to provide this functionality itself.

Maximum speed module 330 may include hardware and/or executable instructions on a machine-readable storage medium configured to determine a speed limit associated with the current location of speed warning device 300. For example, maximum speed module 330 may receive a current location from location module 320. The current location may be expressed in any form known in the art, such as global coordinates or the name of a road. Using the current location, maximum speed module may determine an appropriate maximum speed by accessing a record contained in speed limit storage 340 and indicating the legal speed limit associated with the current location. In various alternative embodiments, maximum speed module 330 may instead query some other network based server via interface 310 for an appropriate speed and speed limit storage 340 may not be present at all.

Speed limit storage 340 may be any machine-readable medium capable of storing correlations between a number of locations and the legal speed limits. Locations may be expressed and stored in any manner known to those skilled in the art. For example, location may be stored as a pair of values indicating latitude and longitude or as the identification of three communications devices used during triangulation and the respective distances between them and the speed warning device 300. Location may alternatively be stored as an indication of a road and/or an indication of a particular stretch of that road. Associated speed limits may be stored in any manner known in the art including, for example, a value indicating the maximum allowed speed in miles or kilometers per hour.

Speed limit storage 340 may be populated with data in any manner known to those of skill in the art. For example, when speed warning device 300 is turned on, speed limit storage 340 may receive a number of speed limit records from another network server device (not shown) via interface 310. Alternatively, speed limit storage 340 could continually receive new and updated records via interface 310 during operation. As a further alternative, speed limit storage 340 may be populated prior to use of speed warning device 300 via another interface (not shown) with a home device (not shown) such as, for example, a personal computer.

Speed module 350 may include hardware and/or executable instructions on a machine-readable storage medium configured to determine the current traveling speed of speed warning device 300. For example, speed module 350 may receive a number of indications of the location of speed warning device 300 measured at different times by location module 320. Speed module 350 may compute a distance traveled between two of these locations and determine the time elapsed between the two location measurements. Using the distance traveled and time elapsed, speed module 350 may then estimate the current traveling speed of speed warning device 300. Alternatively, speed module 350 may not depend on location module 320 and instead receive an indication of the current traveling speed via an interface (not shown) with a component of the vehicle that measures speed such as, for example, a speedometer.

Alarm module 360 may include hardware and/or executable instructions on a machine-readable storage medium configured to determine when it is appropriate to warn the operator of the vehicle that the vehicle is exceeding the speed limit. For example, alarm module 360 may receive an indication of the maximum speed from maximum speed module 330 and an indication of the current speed from speed module 350. Alarm module may compare these values and, if the current speed is greater than the maximum speed, warn the operator via alarm 370.

Alarm 370 may be any means known to those of skill in the art to communicate a warning to the operator of a vehicle. Thus, alarm 370 may include, for example, a display device for displaying a message and/or a warning graphic to the operation. Alarm 370 may also include an audio device for playing an aural warning to the operator such as, for example, a sound effect, a music clip, or a voice indication. In various embodiments, alarm 370 may include an interface for sending an alarm signal to the vehicle. The vehicle may then be able to deliver a visual and/or aural warning to its operator using its own capabilities. Various exemplary embodiments also provide for communicating the current speed, a projected speed, and/or the speed limit to the operator via any of the previously described alarm means.

Various alternative embodiments may further provide localization features. Using the location determined by location module 320, speed warning device 300 may determine standards and customs associated with the current location and provide the option of updating a component of speed warning device 300 or another interface of the vehicle accordingly. For example, speed warning device may determine that a particular native language is associated with the current location, that the native language is different from the current set language of a user interface, and provide the user with the option to change the set language of the user interface to the native language. As a further example, if the speed warning device 300 is currently set to use values measured according to the metric system and speed warning device 300 determines that the current location predominantly uses U.S. customary units, speed warning device may offer the user the option of setting speed warning device 300 to values measure according to U.S. customary units. Speed warning device 300 may obtain such localization information via interface 310 or from a localization storage (not shown) within speed warning device 310.

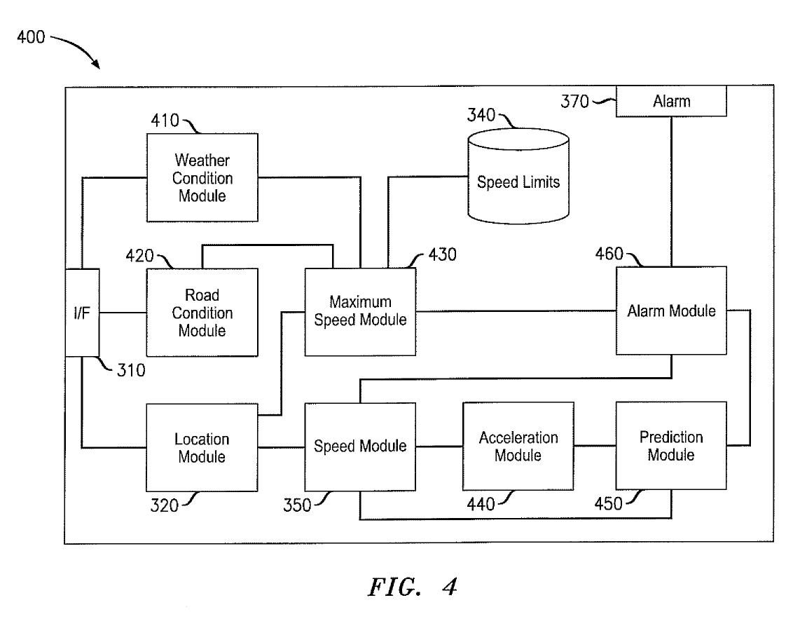

FIG. 4 is a schematic diagram of an alternative implementation of a speed warning device 400. Speed warning device 400 may contain components that are the same as those in speed warning device 300, such as interface 310, location module 320, speed limit storage 340, speed module 350, and alarm 370. Speed warning device 400 may also contain additional or modified components such as weather condition module 410, road condition module 420, maximum speed module 430, acceleration module 440, prediction module 450, and alarm module 460.

Weather condition module 410 may include hardware and/or executable instructions on a machine-readable storage medium configured to determine at least one weather condition associated with the current location. For example, weather condition module 410 may receive a weather report signal, such as an RSS feed, via interface 310 that indicates at least one weather condition for the current location. Weather condition module 410 may receive an indication of the current location from location module 320 such as, for example, a zip code. Weather condition module 410 may then search the received signal for an indication of a weather condition associated with the zip code. Alternatively, weather condition module 410 may transmit a request signal indicating that only weather reports for the current zip code should be transmitted to speed warning device 400. As a further alternative, weather condition module 410 may include an interface for receiving weather-related information directly from other components of the vehicle such as, for example, a thermometer, moisture sensor, or tire-slippage sensor.

Road condition module 420 may include hardware and/or executable instructions on a machine-readable storage medium configured to determine at least one road condition associated with the current location. For example, road condition module 420 may receive a traffic report signal and/or a road construction report signal, such as an RSS feed, via interface 310 from a network server. Using such signals, road condition module 420 may determine at least one road condition associated with the current location such as, for example, “heavy traffic,” “traffic accident,” or “road construction.” Road condition module 420 may receive an indication of the current location from location module 320 such as, for example, a zip code or a road name. Road condition module 420 may then search the received signals for an indication of a road condition associated with the current location. Alternatively, road condition module 420 may transmit a request signal indicating that only road-related reports for the current location should be transmitted to speed warning device 400.

Maximum speed module 430 may include hardware and/or executable instructions on a machine-readable storage medium configured to determine an appropriate maximum speed which the vehicle should not exceed in light of factors such as the speed limit in force, the weather, and/or the current road conditions. Maximum speed module 430 may perform the same functions described above in connection with maximum speed module 330.

Maximum speed module 430 may additionally adjust the legal speed limit in light of weather and/or road conditions to produce a maximum speed that is lower than the legal speed limit. For example, maximum speed module 430 may receive an indication of a current weather condition from weather condition module 410 and reduce the speed limit by a percentage or fixed value associated with that weather condition. Likewise, maximum speed module 430 may receive an indication of a current road condition from road condition module 420 and reduce the speed limit by a percentage or fixed value associated with that road condition.

The amounts by which the speed limit is decreased for each weather and/or road condition may be preprogrammed in speed warning device 300 or the values may be set by the operator or some other user. Additionally, the operator or another user may be allowed to disable the consideration of weather and/or road conditions by maximum speed module 430 altogether.

Acceleration module 440 may include hardware and/or executable instructions on a machine-readable storage medium configured to determine the current acceleration of the speed warning device 400. For example, acceleration module may receive a number of speed measurements made by speed module 350 at different times. Acceleration module 440 may compute a change in speed between two such speed measurements and determine the time elapsed between the two speed measurements. Using the change in speed and time elapsed, acceleration module 440 may then estimate the current acceleration of speed warning device 400. Alternatively, acceleration module may not depend on speed module 350 and instead receive an indication of the current acceleration via an interface (not shown) with a component of the vehicle that measures acceleration such as, for example, an accelerometer.

Prediction module 450 may include hardware and/or executable instructions on a machine-readable storage medium configured to predict a future traveling speed of speed warning device 400. For example, prediction module may receive a current speed from speed module 350 and a current acceleration from acceleration module 440. Prediction module 450 may then estimate the amount by which the current speed may increase after the passage of a predetermined time by multiplying the current acceleration by the predetermined time period. The predetermined time may be a preprogrammed value or it may be manually set by the operator or another user. Prediction module may then predict the speed at which speed warning device may be traveling after the passage of the predetermined time by adding the estimated speed increase or decrease to the current speed.

Alarm module 460 may include hardware and/or executable instructions on a machine-readable storage medium configured to determine when it is appropriate to warn the operator that the vehicle is either currently exceeding or likely to exceed the appropriate maximum speed. Alarm module 460 may perform the same functions described above in connection with alarm module 360. Alarm module 460 may additionally receive a predicted speed from prediction module 450. Alarm module 460 may compare the predicted speed to the appropriate maximum speed received from maximum speed module 430. If the predicted speed exceeds the appropriate maximum speed, alarm module 460 may then warn the operator via alarm 370. The warning may simply be a generic warning used for both current and predicted speed violations or there may be different warnings for current and predicted speed violations. For example, alarm module 460 may display the message “SLOW DOWN” via alarm 370 when the speed warning device 400 is currently exceeding the maximum speed and may display the message “YOU ARE NEARING THE SPEED LIMIT” via alarm 370 when the speed warning device 400 is merely predicted to exceed the maximum speed. The operator or another user may additionally be allowed to disable speed prediction, and thus warnings based on predicted speeds and acceleration, altogether.

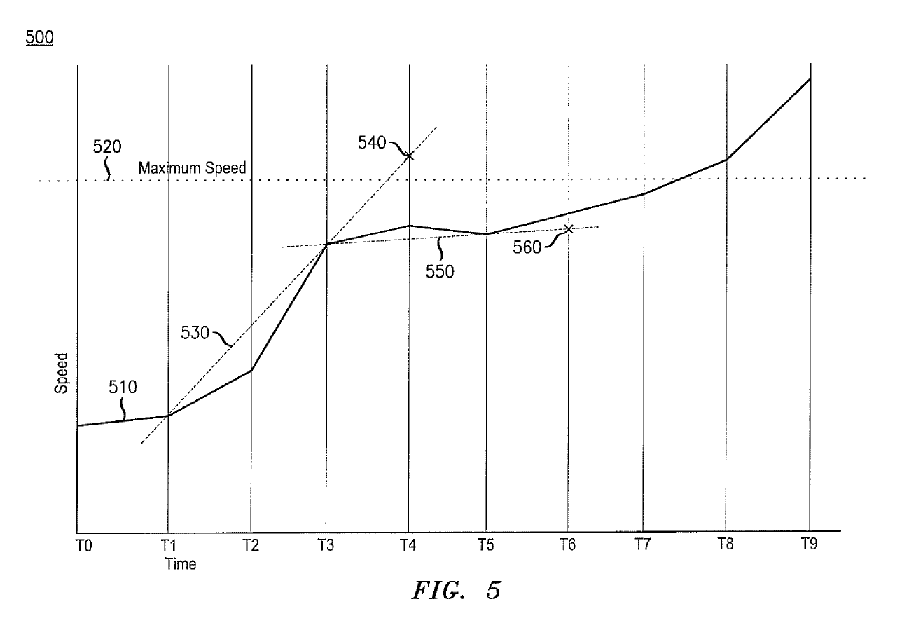

FIG. 5 is a graph 500 of an exemplary set of speeds 510 measured by a speed warning device 110 over a specific time period. Graph 500 includes an x-axis indicating ten points in time T0-9 and a y-axis indicating the relative speed measurement. Graph 500 further includes line 510, indicating the measured speed at each time point T0-T9, and line 520, indicating the appropriate maximum speed as determined by speed warning device 110.

As indicated by graph 500, the current speed of speed warning device 110 exceeded the maximum speed 520 at time points T8, T9. At each of these time points T8, T9, speed warning device 110 may have warned the operator that they were exceeding the appropriate maximum speed.

Graph 500 also shows two speed predictions 540, 560 made at time points T3, T5 respectively. At time T3, speed warning device 110 may have predicted future speed 540 by first determining the change in speed between time points T1, T3. It should be noted that any time period could be used to estimate the current acceleration of speed warning device 110 independent of the speed sampling rate. The embodiment of speed warning device 110 described by graph 500 uses a time period of two for acceleration estimation. Accordingly, the current speed at time T3 and the previous speed measured two time periods in the past (i.e., at time T1) are used, skipping the speed measured at time T2.

Using the two speed values, speed warning device 110 may predict a future speed, as indicated by prediction line 530. Prediction line 530 passes through the two speed data points at time points T1, T3. Thus, the slope of prediction line 530 represents the estimated acceleration at time T3. By extending prediction line 530 (i.e., by adding a multiple of the estimated acceleration to the current speed), speed warning device 110 may predict a future speed 540 for time T4. Because future speed 540 is above the appropriate maximum speed 520, speed warning device 110 may warn the operator that the vehicle is likely to soon exceed the appropriate maximum speed 520. Note that speed warning device 110 may be configured to predict speeds at any point in the future by multiplying the acceleration by an appropriate time period before adding it to the current speed. For example, speed warning device 110 may predict the speed for time T5 at time T3 by adding two times the acceleration to the current speed.

In a similar fashion, speed warning device 110 may at time T5 predict a future speed 560 for time T6. Again, extending the prediction line 550 running through the measured speed points at time T3, T5, speed warning device can predict a future speed for any time in the future. In this case, predicted speed 560 does not exceed maximum speed 520, so speed warning device 110 may not warn the operator of the vehicle.

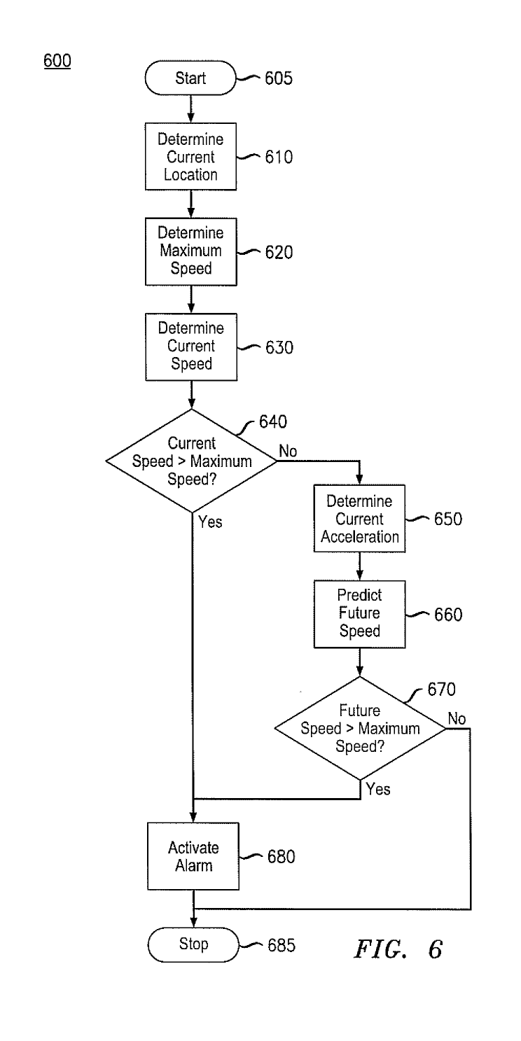

FIG. 6 is a flowchart of an exemplary method 600 for warning a vehicle operator when the speed of a vehicle exceeds or may exceed an appropriate maximum speed. Method 600 may be performed among the components of a speed warning device 110 implemented according to various embodiments such as speed warning devices 300, 400.

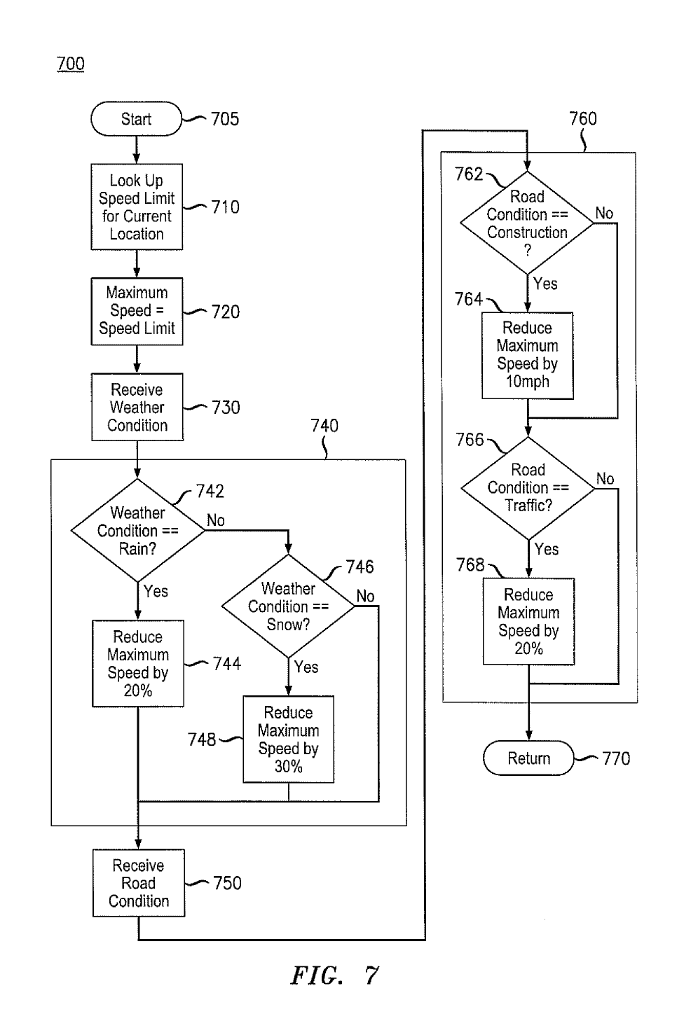

Method 600 starts at step 605 and proceeds to step 610 where location module 320 may determine a current location of speed warning device 110 according to any method known to those of skill in the art such as, for example, triangulation. Method 600 may then move to step 620 where maximum speed module 330, 430 may determine an appropriate maximum speed to enforce. An exemplary implementation of step 620 will be described below with reference to FIG. 7. After determining an appropriate maximum speed, method 600 may move on to step 630 where speed module 350 may determine the current speed of speed warning device 110 according to any method known to those of skill in the art such as, for example, estimation based on location sampling. Method 600 may then move on to step 640.

At step 640, alarm module 360,460 may determine whether the speed warning device 110 is currently exceeding the appropriate maximum speed by comparing the current speed to the maximum speed. If speed warning device 110 is exceeding the maximum speed, method 800 will proceed to step 680 where alarm module 360, 460 may warn the operator via alarm 370.

If, on the other hand, speed warning device 110 determines at step 640 that it is not exceeding the maximum speed, method 600 will proceed to step 650. Note that in the case of an implementation that does not predict future speeds, such as speed warning device 300, method 600 may simply proceed to end at step 685. At step 650, acceleration module 440 may determine a current acceleration for speed warning device 110 by, for example, estimation based on speed sampling. Method 600 may then proceed to step 660 where prediction module 450 may predict a future speed of speed warning device 110 by, for example, predicting the speed increase based on the current acceleration and adding the estimated speed increase to the current speed.

Method 600 may then proceed to step 670 where alarm module 460 may determine whether speed warning device 110 may exceed the maximum speed at some point in the future. Alarm module 460 may determine this by, for example, comparing the predicted speed to the appropriate maximum speed. If alarm module determines that speed warning device 110 is likely to exceed the maximum speed soon, method 600 may proceed to step 680 where, as described above, alarm module 360, 460 may warn the operator via alarm 370. From step 680, method 600 may move on to stop at step 685. If, at step 670, alarm module instead determines that speed warning device 110 was not likely to exceed the maximum speed, method 600 may proceed directly to step 685 and stop.

FIG. 7 is a flowchart of an exemplary method 700 for determining an appropriate maximum speed which a vehicle should not exceed. Method 700 may correspond to step 620 of method 600 and may be performed by the components of a speed warning device 110 implemented according to various embodiments such as speed warning devices 300, 400.

Method 700 may begin in step 705 and proceed to step 710 where maximum speed module 330,430 may determine a speed limit associated with the current location by, for example, accessing a record of speed limit database 340. Method 700 may then proceed to step 720 where maximum speed module 330, 430 may set the appropriate maximum speed to equal the applicable speed limit. In embodiments that do not support consideration of weather and road conditions, such as speed warning device 300, method 700 may then proceed to end at step 765.

In embodiments that do support consideration of weather and road conditions, such as speed warning device 400, method 700 may then proceed to step 730 where weather condition module 410 may receive an indication of at least one current weather condition for the current location. Method 700 may then proceed to routine 740, where maximum speed module 430 may modify the maximum speed according to the received weather condition.

Routine 740 may account for any number of weather conditions and may take any action in response. As shown, the example routine 740 monitors for two weather conditions: “rain” and “snow.” At step 742, maximum speed module 430 may determine whether the received weather condition indicates “rain.” If so, routine 740 may proceed to step 744 where the appropriate maximum speed may be reduced by 20%. The value of reduction may be a percentage or a literal value. The value of reduction may further be a preprogrammed value or may be set by the operator or another user. Method 700 may then proceed to step 750.

If it is determined at step 742 that the weather condition does not indicate “rain,” routine 740 may proceed to step 746, where maximum speed module 430 may determine whether the received weather condition indicates “snow.” Note that the conditions “rain” and “snow” are presented in this example as alternatives to each other. That is to say, maximum speed module 430 will only consider a “snow” condition if there is no “rain” condition. Routine 740 may also be implemented in a manner such that multiple conditions may be evaluated. For example, a person of skill in the art would be capable of adding an evaluation for a “wind” condition could to routine 740, such that the new evaluation step would be entered from any of the branches out of steps 742, 746. In this manner, an indication of “wind” could lead to additional reduction of the maximum speed, regardless of whether there is also a “rain” or “snow” condition.

At step 746, if the weather condition is determined to indicate “snow,” routine 740 may proceed to step 748 where maximum speed module 430 may reduce the maximum speed by 30%, or any other appropriate value as described above in connection with step 744. Method 700 may then proceed to step 750. If the weather condition is not determined to indicate “snow,” method 700 may proceed to step 750.

At step 750, road condition module 420 may receive an indication of at least one current road condition for the current location. Method 700 may then proceed to routine 760 where maximum speed module 430 may modify the maximum speed according to the received road condition.

Routine 760 may account for any number of road conditions received by road condition module 420. At step 764, maximum speed module 430 may determine whether the received road condition indicates “construction” for the current location. If so, routine 760 may proceed to step 764 where the maximum speed may be reduced by 10 mph or any other appropriate value as described above in connection with step 744. Routine 760 may proceed to step 766 after execution of step 764 or after determining, at step 762, that the received road condition does not indicate “construction.”

At step 766, maximum speed module 430 may determine whether the received road condition indicates “traffic.” If so, routine 760 may proceed to step 768 where maximum speed module 430 may reduce the maximum speed by 20% or any other appropriate value as described above in connection with step 744. Method 700 may proceed to step 770 either after execution of step 764 or after determining, at step 762, that the received road condition does not indicate “traffic.” Method 700 may then stop at step 770. This may include returning to the execution of method 600.

According to the foregoing, various exemplary embodiments provide for a method and device for actively warning an operator of a vehicle that they are driving too fast. In particular, by automatically determining a current speed and an applicable speed limit, an electronic device may immediately warn an operator when they are exceeding the speed limit. Further, by monitoring the acceleration of the vehicle, the device may intelligently issue a preemptive warning when the operator is in danger of exceeding the speed limit in the future. Additionally, by receiving indications of weather and road conditions, the electronic device may adjust the appropriate maximum speed downward to provide more intelligent recommendations as to whether the vehicle should be slowed down.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine. Thus, a machine-readable storage medium may include read-only memory (ROM), random-access memory (RAM), magnetic disk storage media, optical storage media, flash-memory devices, and similar storage media.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method performed by an electronic device for providing speed alerts to an operator of a vehicle, the method comprising:
determining, by the electronic device, a current location of the vehicle;
determining, for the current location, an appropriate maximum speed which the vehicle should not exceed;
determining a current speed at which the vehicle is traveling;
determining whether the current speed is greater than the appropriate maximum speed; and
indicating to the operator of the vehicle, when the current speed is greater than the appropriate maximum speed, that the vehicle is traveling at a speed that is greater than the appropriate maximum speed.

2. The method of claim 1, wherein the step of determining the appropriate maximum speed comprises determining a legal speed limit associated with the current location of the vehicle.

3. The method of claim 2, wherein the step of determining the appropriate maximum speed further comprises:
determining a current condition associated with the current location of the vehicle;
determining an adjustment value associated with the current condition; and
adjusting the determined speed limit downward according to the adjustment value to obtain the appropriate maximum speed.

4. The method of claim 3, wherein the adjustment value is a value previously chosen by the operator to be associated with the current condition.

5. The method of claim 2, wherein the step of determining the appropriate maximum speed comprises:
determining a current weather condition associated with the current location;
determining a current road condition associated with the current location; and
modifying the legal speed limit according to both the weather condition and the road condition to obtain the appropriate maximum speed.

6. The method of claim 1, further comprising:
determining a current acceleration of the vehicle;
predicting a future speed of the vehicle using the current speed and the current acceleration;
comparing the future speed to the appropriate maximum speed; and
indicating to the operator of the vehicle, when the future speed is greater than the appropriate maximum speed, that the vehicle is likely to be traveling at a speed that is greater than the appropriate maximum speed in the future.

7. The method of claim 1, wherein the electronic device is a cellular telephone and the step of determining a current location comprises:
determining a location of a first cellular tower;
determining a first distance from the first cellular tower;
determining a location of a second cellular tower;
determining a second distance from the second cellular tower;
determining a location of a third cellular tower;
determining a third distance from the third cellular tower; and
triangulating the current location of the cellular telephone using the first, second, and third locations and the first, second, and third distances.

8. The method of claim 1, wherein the electronic device is a component of the vehicle.

9. An electronic device for providing speed alerts to an operator of a vehicle, the electronic device comprising:
a location module that determines a current location of the vehicle;
a maximum speed module that determines, for the current location, an appropriate maximum speed which the vehicle should not exceed;
a speed module that determines a current speed of the vehicle; and
an alarm module that:
determines whether the current speed is greater than the appropriate maximum speed, and
indicates to the operator of the vehicle, when the current speed is greater than the appropriate maximum speed, that the vehicle is traveling at a speed that is greater than the appropriate maximum speed.

10. The electronic device of claim 9, further comprising:
a speed limit database that contains a plurality of speed limit records, wherein each speed limit record includes a location and a posted speed limit associated with the location,
wherein, in determining the appropriate maximum speed, the maximum speed module retrieves a current speed limit associated with the current location from the speed limit database.

11. The electronic device of claim 10, further comprising:
a weather condition module that receives a weather condition associated with the current location,
wherein, in determining the appropriate maximum speed, the maximum speed module adjusts the appropriate maximum speed according to the received weather condition.

12. The electronic device of claim 10, further comprising:
a road condition module that receives a road condition associated with the current location,
wherein, in determining the appropriate maximum speed, the maximum speed module adjusts the appropriate maximum speed according to the received road condition.

13. The electronic device of claim 10, further comprising:
a weather condition module that receives a weather condition associated with the current location; and
a road condition module that receives a road condition associated with the current location,
wherein, in determining the appropriate maximum speed, the maximum speed module adjusts the appropriate maximum speed according to both the received weather condition and the received road condition.

14. The electronic device of claim 9, further comprising:
an acceleration module that determines a current acceleration of the vehicle; and
a speed prediction module that predicts a future speed of the vehicle using the current speed and the current acceleration,
wherein the alarm module further:
compares the future speed to the appropriate maximum speed, and
indicates to the operator of the vehicle, when the future speed is greater than the appropriate maximum speed, that the vehicle is likely to be traveling at a speed that is greater than the appropriate maximum speed in the future.

15. The electronic device of claim 9, wherein the electronic device is integrated into the vehicle.

16. A machine-readable storage medium encoded with instructions for providing, by an electronic device, speed alerts to an operator of a vehicle, the machine-readable storage medium comprising:
instructions for determining a current location of the vehicle;
instructions for determining, for the current location, an appropriate maximum speed which the vehicle should not exceed;
instructions for determining a current speed at which the vehicle is traveling;
instructions for determining whether the current speed is greater than the appropriate maximum speed; and
instructions for indicating to the operator of the vehicle, when the current speed is greater than the appropriate maximum speed, that the vehicle is traveling at a speed that is greater than the appropriate maximum speed.

17. The machine-readable storage medium of claim 16, wherein the instructions for determining the appropriate maximum speed comprise instructions for determining a legal speed limit associated with the current location.

18. The machine-readable storage medium of claim 17, wherein the instructions for determining the appropriate maximum speed further comprise instructions for determining a current weather condition associated with the current location.

19. The machine-readable storage medium of claim 17, wherein the instructions for determining the appropriate maximum speed further comprise instructions for determining a current road condition associated with the current location.

20. The machine-readable storage medium of claim 16, further comprising:
instructions for determining a current acceleration of the vehicle;
instructions for predicting a future speed of the vehicle using the current speed and the current acceleration;
instructions for comparing the future speed to the appropriate maximum speed; and
instructions for indicating to the operator of the vehicle, when the future speed is greater than the appropriate maximum speed, that the vehicle is likely to be traveling at a speed that is greater than the appropriate maximum speed in the future.

21. The method of claim 1, further comprising:
determining a native language associated with the current location;
determining a current language of the electronic device;
determining whether the current language is the same as the native language; and
when the current language is not the same as the native language, providing the user with an option to set the native language as the current language of the electronic device.

22. The method of claim 1, further comprising:
determining a native measurement system associated with the current location;
determining a current measurement system of the electronic device;
determining whether the current measurement system is the same as the native measurement system; and
when the current measurement system is not the same as the native measurement system, providing the user with an option to set the native measurement system as the current measurement system.
